(19) United States
(12) Patent Application Publication
(10) Pub. No.: US 2026/0023498 A1
(43) Pub. Date: Jan. 22, 2026

(54) BUILT-IN SELF POWER MONITORING FOR MEMORY DEVICES

(71) Applicant: MICRON TECHNOLOGY, INC., Boise, ID (US)

(72) Inventors: Yoke Keong Ho, Singapore (SG); Guang Shen, Shanghai (CN); Charlie Chen, Shanghai (CN); Suresh Rajgopal, San Diego, CA (US)

(21) Appl. No.: 19/272,311

(22) Filed: Jul. 17, 2025

Related U.S. Application Data
(60) Provisional application No. 63/673,111, filed on Jul. 18, 2024.

(51) Int. Cl. G06F 3/06

(52) U.S. Cl. CPC G06F 3/0653; G06F 3/0625; G06F 3/0679

(57) ABSTRACT

A system including a memory device; a built-in device that measures a voltage of the memory device; and a processing device, operatively coupled with the built-in device and the memory device, to perform operations including detecting a trigger for the system to enter a power monitoring mode; causing the system to enter the power monitoring mode; causing the system to exit the power monitoring mode and, upon exiting the power monitoring mode, storing a voltage and a current derived from an analog to digital converter (ADC) conversion; calculating a power based on the voltage and a current derived from the ADC conversion, wherein the power reflects a power consumption of the system at a specific time point; and storing an indication of the power in a log.

### RELATED APPLICATIONS

This application claims the benefit of U.S. Provisional Patent Application No. 63/673,111, filed Jul. 18, 2024, the entire contents of which are incorporated by reference herein.

### TECHNICAL FIELD

Embodiments of the disclosure relate generally to memory sub-systems, and more specifically, relate to systems and methods for built-in self power monitoring for memory devices in memory sub-systems.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory sub-system in accordance with some embodiments of the present disclosure.

FIG. 2 illustrates an example computing system that implements built-in self power monitoring for a memory device in a memory sub-system, in accordance with some embodiments of the present disclosure.

FIG. 3 illustrates a flow diagram of an example method for built-in self power monitoring for a memory device in a memory sub-system, in accordance with some embodiments of the present disclosure.

FIG. 4 illustrates an example data structure for implementing built-in self power monitoring for a memory device in a memory sub-system, in accordance with some embodiments of the present disclosure.

FIG. 5 is a block diagram of an example computer system in which embodiments of the present disclosure can operate.

### DETAILED DESCRIPTION

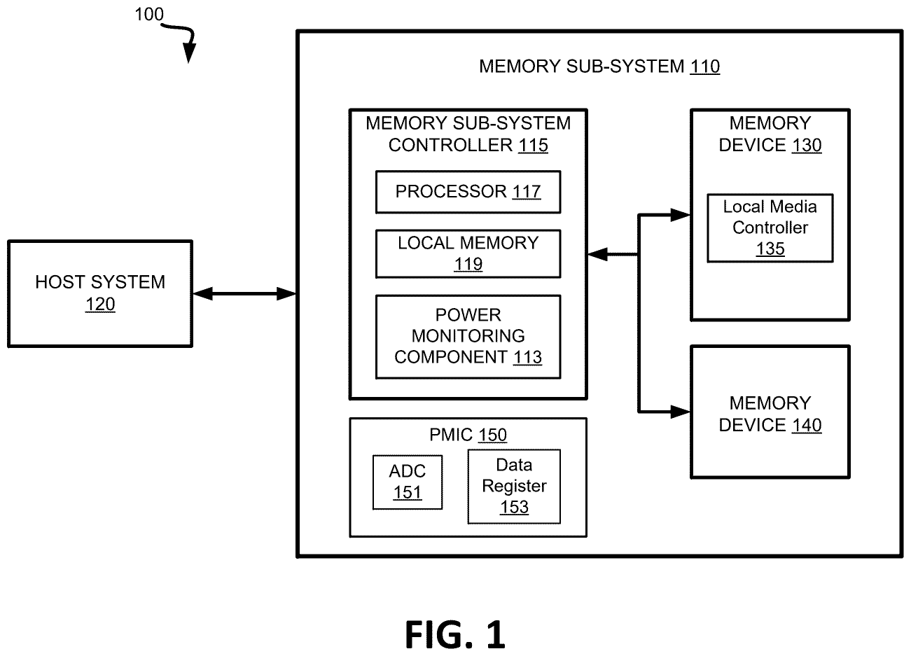

Aspects of the present disclosure are directed to systems and methods for built-in self power monitoring for memory devices. A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1. Each of the memory devices can include one or more arrays of memory cells. A memory cell (“cell”) is an electronic circuit that stores information. Depending on the cell type, a cell can store one or more bits of binary information, and has various logic states that correlate to the number of bits being stored. The logic states can be represented by binary values, such as “0” and “1”, or combinations of such values. For example, a single-level cell (SLC) can store one bit of information and has two logic states. Similarly, a multi-level cell (MLC) can store two bits per cell, a triple-level cell (TLC) can store three bits per cell, a quad-level cell (QLC) can store four bits per cell, and a penta-level cell (PLC) can store five bits per cell. The memory sub-system includes a memory sub-system controller that can communicate with the memory devices to perform operations such as reading data, writing data, or erasing data at the memory devices and other such operations. A memory sub-system controller is described in greater below in conjunction with FIG. 1.

In some systems, measuring the power consumption in a memory sub-system becomes demanding, such as in a hyperscale system or data center. Although such measurement can be performed through an external device, using an external device may bring several limitations, including the fact that real-time measurements and scaling of such measurements are hard to implement, that the communication with external devices may have undesired effects towards the performance of the memory sub-system, etc.

Aspects of the present disclosure address the above and other deficiencies by implementing a built-in self power monitoring component for memory devices in the memory sub-system. The built-in self power monitoring component may include a hardware component and a firmware component. In one embodiment, the firmware component can detect a triggering event for the power monitoring of the memory sub-system, such as by using a timer (e.g., activated periodically in a predetermined time interval) provided by the memory sub-system or a message (e.g., an interrupt signal indicating the hardware component is ready) received from the hardware component. Responsive to detecting the triggering event, the firmware component can cause the memory sub-system to enter the power monitoring mode. The firmware component can first check whether a pending monitoring result is available, such as, for example, voltage(s) and current(s) stored in a data register in the hardware component. When the firmware component determines that a pending monitoring result is available, the firmware component can retrieve the pending monitoring result. When the firmware component determines that no pending monitoring result is available, the firmware component can start a power monitoring function provided by the hardware component. In some cases, the power monitoring function is an analog to digital converter (ADC) conversion performed by the hardware component. The ADC conversion involves measuring the voltage of the memory sub-system, calculating the current based on the voltage according to a predefined relation between the current and the voltage, and digitizing the current/voltage. The measured voltage and the calculated current are stored in a data register in the hardware component. To determine whether the ADC conversion is completed, the firmware component may have two paths, which can be differentiated by the sampling interval of power monitoring. The sampling interval of power monitoring refers to the time between measurements are taken for power monitoring. In some implementations, the sampling interval can be predefined during manufacturing or customized by a user of the memory sub-system.

In some implementations, the firmware component may determine that the sampling interval is less than or equal to a threshold value (e.g., 2 ms) and keep checking the status of ADC conversion until ADC conversion is completed. The threshold value may be a parameter associated with the performance of the hardware component and may be predetermined through testing. For example, the firmware component may keep polling the information representing the status of the ADC conversion (e.g., a bit of a register) from the hardware component. Responsive to receiving the status of the ADC conversion that the ADC conversion is completed, the firmware component may retrieve the result of the ADC conversion, including the measured voltage and the calculated current that are stored in the data register in the hardware component. In some implementations, the firmware component may determine that the sampling interval is more than a threshold value (e.g., 2 ms), determine that a message (e.g., an interrupt indicating that the ADC conversion is completed and the result of the ADC conversion is available for retrieving) has been received from the hardware component, and retrieve the result of the ADC conversion.

In some implementations, responsive to retrieving the result of the ADC conversion, the firmware component may cause the memory sub-system to exit the power monitoring mode. The firmware component may store the retrieved voltage and current, and calculate the power by multiplying the voltage with the current. The power reflects a power consumption of the memory sub-system at a specific time point. The firmware component may store the information of the power in a log. The above-described operations may correspond to a time point, and the firmware component may cooperate with the hardware component to recursively perform the above-described operations to obtain a set of powers, each corresponding to one time point of a period of time. The firmware component may perform a statistical calculation or analysis over the set of powers corresponding to the period of time to present a statistical value (e.g., mean) of power during the period of time. As for the monitoring purpose, the firmware component is capable to obtaining several sets of powers corresponding to several periods of time.

Advantages of the present disclosure include providing real-time measurement and monitoring of power in a memory sub-system. The aspects of the present disclosure provide an optimized way to measure and monitor the power consumption in a hyperscale system or a data center.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., the one or more memory device(s) 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device(s) 130) include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory device(s) 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 115 (or controller 115 for simplicity) can communicate with the memory device(s) 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device(s) 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 130. The memory sub-system controller 115 can further include host interface circuitry to communicate with the host system 120 via the physical host interface. The host interface circuitry can convert the commands received from the host system into command instructions to access the memory device(s) 130 as well as convert responses associated with the memory device(s) 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device(s) 130.

In some embodiments, the memory device(s) 130 include local media controllers 135 that operate in conjunction with memory sub-system controller 115 to execute operations on one or more memory cells of the memory device(s) 130. An external controller (e.g., memory sub-system controller 115) can externally manage the memory device 130 (e.g., perform media management operations on the memory device(s) 130). In some embodiments, a memory device 130 is a managed memory device, which is a raw memory device (e.g., memory array) having control logic (e.g., local controller 135) for media management within the same memory device package. An example of a managed memory device is a managed NAND (MNAND) device. Memory device(s) 130, for example, can each represent a single die having some control logic (e.g., local media controller 135) embodied thereon. In some embodiments, one or more components of memory sub-system 110 can be omitted.

In one embodiment, memory sub-system 110 includes a power monitoring component 113 that can monitor power of the memory sub-system or the memory devices. In some embodiments, memory sub-system controller 115 includes at least a portion of power monitoring component 113. In some embodiments, power monitoring component 113 is part of an application, or an operating system. In other embodiments, local media controller 135 includes at least a portion of power monitoring component 113 and is configured to perform the functionality described herein. Further details with regards to the operations of power monitoring component 113 are described below.

In one embodiment, memory sub-system 110 includes a power management integrated circuit (PMIC) 150 that is coupled with power monitoring component 113 to perform the functionality described herein. In one embodiment, PMIC 150 can work with SSD, NVDIMM, hard-disk drives, and power back-up systems. In one embodiment, PMIC 150 provides functions of input current limiting, input reverse current blocking, and a bidirectional, boost-buck converter with one inductor for energy storage and system back-up power when there is an input power failure. In one embodiment, PMIC 150 provides an inter-integrated circuit (I²C) interface and an analogue to digital converter (ADC). The I²C interface can be used to write the control command and the monitor system status, set the input current limit, slew rate, and perform cap health tests. In one embodiment, PMIC 150 monitors system status, such as input voltage, input current, storage voltage, temperature, and provides interrupt options for these features.

In one embodiment, PMIC 150 includes an analogue to digital converter (ADC) 151 and a data register 153. The ADC 151 may measure (and/or calculate) instantaneous current and voltage of the memory sub-system 110 or the memory device 130, 140. For example, the measured voltage may be an input voltage (e.g., supplied by a host system) to the memory sub-system 110 or the memory device 130, 140. The data register 153 may store the result that is output from the ADC 151. In some embodiments, memory sub-system controller 115 includes at least a portion of PMIC 150. In some embodiments, PMIC 150 is part of the memory device 130, 140. In other embodiments, local media controller 135 includes at least a portion of PMIC 150 and is configured to perform the functionality described herein. Further details with regards to the operations of PMIC 150 are described below.

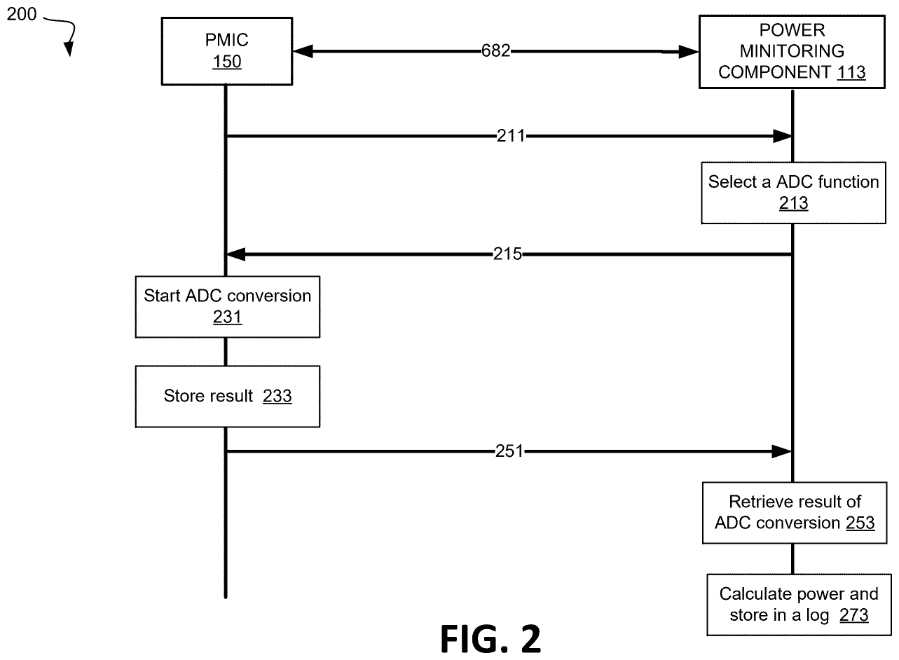

FIG. 2 illustrates an example of power monitoring component 113 and PMIC 150 in the memory sub-system 110 and the communication between power monitoring component 113 and PMIC 150, in accordance with some embodiments. Power monitoring component 113 and PMIC 150 may communicate via I²C interface 682.

In one embodiment, PMIC 150 may send a message 211 to power monitoring component 113, where the message 211 indicates that ADC 151 is ready (i.e., can be interrupted) to perform certain functions, including the current/voltage measurement. In some implementations, the message 211 may be an unmask interrupt of ADC done, which means that when the ADC conversion performed by ADC 151 is completed, the power monitoring component 113 will receive an indication (e.g., interrupt 251) of the completion of the ADC conversion.

Power monitoring component 113 may select 213 a function among multiple functions (e.g., a list of functions) that can be performed by PMIC 150, where the selected function is an ADC conversion performed by ADC 151 to output instantaneous voltage and current measurement/calculation.

Upon selecting the function, power monitoring component 113 may send an instruction 215 to PMIC 150 to start the ADC conversion. In some implementations, the instruction 215 may set a bit (e.g., a “ADC enable” bit) in a register of PMIC 150, where the bit value “1” represents the ADC conversion is enabled and the bit value “0” represents the ADC conversion is disabled.

PMIC 150 may start the ADC conversion 231, which means that ADC 151 may perform the ADC conversion that outputs a measurement of the voltage and calculation of the current based on the measured voltage.

When the ADC conversion is completed, PMIC 150 may obtain a measured voltage, use the measured voltage to calculate the current, and store the result 233 including the voltage and current in the data register 153. The current may be calculated based on a pre-defined linear relationship with the voltage. For example, the current I_{IN} may be calculated according to the formula:

$${I}_{IN} - \frac{{V}_{ILIM} * 64.26}{{R}_{ILIM} ( k Ω )} + 0.08 ,$$

where V_{ILIM} is the voltage, and R_{ILIM} is a predefined value.

When the ADC conversion is completed, PMIC 150 may set a bit (e.g., a “ADC done” bit) in the register of PMIC 150, where the bit value “1” represents that the ADC conversion is completed and the bit value “0” represents no ADC conversion occurs or the ADC conversion is not completed.

PMIC 150 may send, to power monitoring component 113, a message 251 indicating that the ADC conversion is completed. The message 251 may be an interrupt of ADC done. Upon receiving the message 251, the power monitoring component 113 may determine whether the message 251 indicates that the ADC conversion is completed, and responsive to determining that the message 251 indicates that the ADC conversion is completed, retrieve result of the ADC conversion 253, including the voltage and current stored in the data register 153. For example, the power monitoring component 113 may directly read the result in the data register 153. In another example, the power monitoring component 113 may communicate with the PMIC 150 to retrieve the result stored in the data register 153.

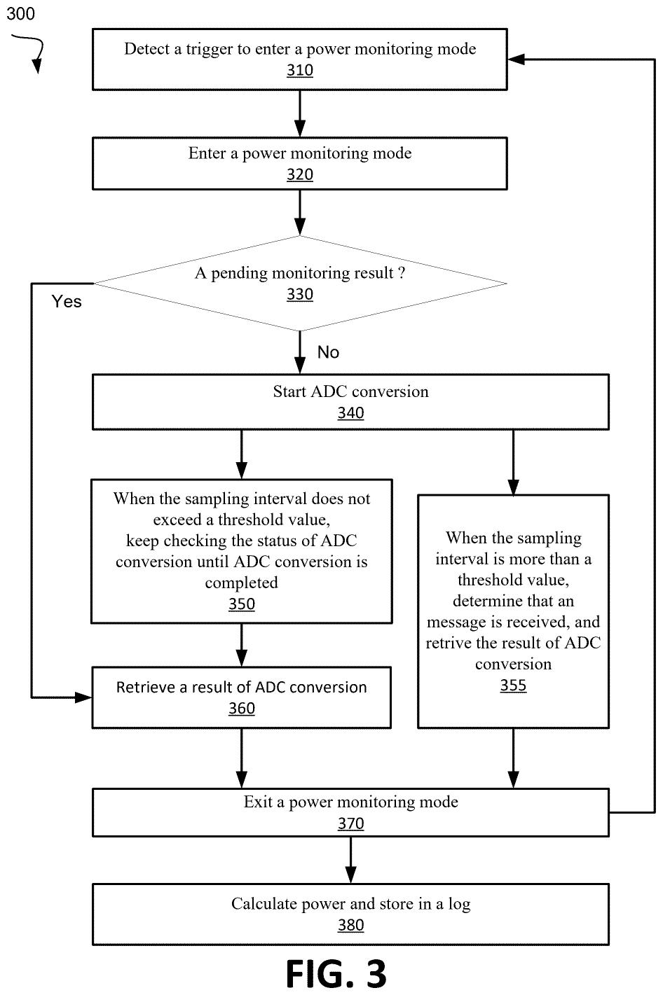

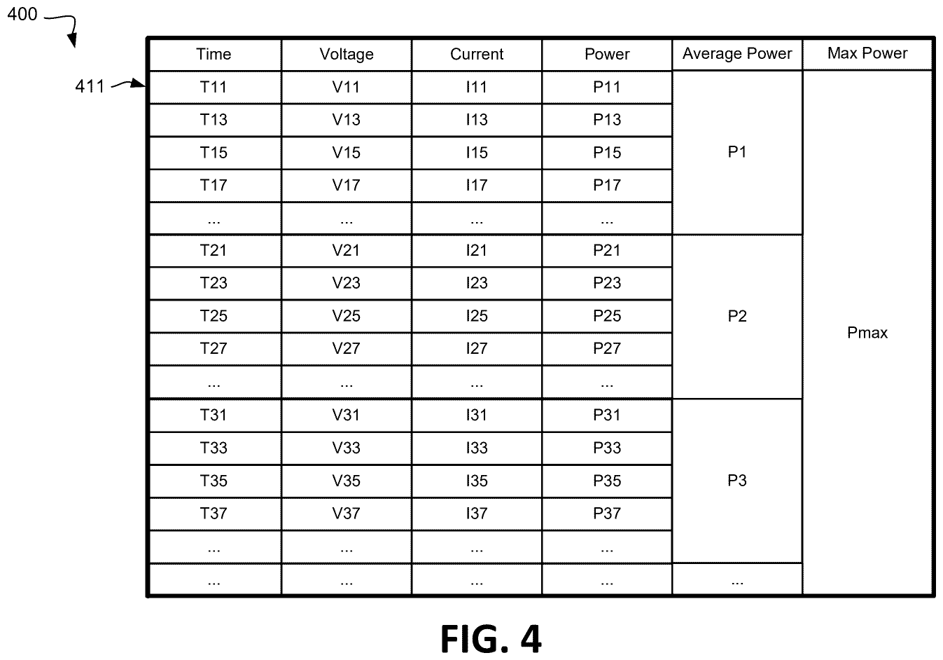

The power monitoring component 113 may then use the retrieved voltage and current to calculate power and store the power information in a log 273. The detail of the power calculation and log storing is illustrated with respect to FIGS. 3 and 4.

FIG. 3 illustrates an example operation in a method 300 for built-in self power monitoring for a memory device in a memory sub-system, in accordance with some embodiments. The method 300 can be performed by processing device that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by power monitoring component 113 of FIGS. 1 and 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 310, the processing device may detect a trigger for the memory sub-system to enter a power monitoring mode. In some implementations, the trigger may be detected upon a timer being active, where the timer is activated periodically in a predetermined time interval. For example, the processing device may set the timer in the configuration file of the memory sub-system (e.g., memory sub-system 110) or the memory device (e.g., memory device 130) in the memory sub-system. In some implementations, the trigger may be detected upon a message being received. For example, the processing device may determine whether a message (e.g., message 211) indicating that ADC (e.g., ADC 151) in the built-in device (e.g., PMIC 150) is ready to perform a function is received from the built-in device (e.g., PMIC 150).

At operation 320, responsive to detecting the trigger to enter a power monitoring mode, the processing device may cause the memory sub-system to enter the power monitoring mode. At operation 330, the processing device may determine whether a pending monitoring result is available (e.g., whether a measurement result of the ADC conversion is pending to be retrieved). In some implementations, to determine whether a pending monitoring result is available, the processing device may check a bit (e.g., a “pending result” bit) of a register in the processing device, where a bit value “1” represents that a pending monitoring result is available and a bit value “0” represents that a pending monitoring result is not available. In some implementations, to determine whether a pending monitoring result is available, the processing device may communicate with the built-in device (e.g., PMIC 150) to check a bit (e.g., a “ADC done” bit) of a register in the built-in device (e.g., PMIC 150). In some implementations, the built-in device (e.g., PMIC 150) may check a bit (e.g., a “ADC done” bit) of a register in the built-in device (e.g., PMIC 150), where a bit value “1” represents that an ADC conversion is completed that a pending monitoring result is available and a bit value “0” represents an ADC conversion is not completed that no pending monitoring result is available.

Responsive to determining that a pending monitoring result is available, at operation 360, the processing device may retrieve a result of the ADC conversion that is stored in the built-in device (e.g., PMIC 150).

Responsive to determining that no pending monitoring result is available, at operation 340, the processing device may start ADC conversion. In some implementations, the processing device may perform the ADC conversion and determine whether the ADC conversion is completed. Upon starting the ADC conversion, the processing device may have two paths to detect the completion of the ADC conversion. In some implementations, two paths to determine whether the ADC conversion is completed can be differentiated by the sampling interval. For example, the processing device may determine whether a sampling interval is less than or equal to a threshold value (e.g., 2 ms).

In some implementations, at operation 350, the processing device may determine that the sampling interval is less than or equal to a threshold value (e.g., 2 ms) and keep checking the status of ADC conversion until ADC conversion is completed. For example, the processing device may keep polling the information representing the status of the ADC conversion from the built-in device (e.g., PMIC 150). For example, the information representing the status of the ADC conversion may be stored in a bit (e.g., a “ADC done” bit) of a register in the built-in device (e.g., PMIC 150), and the built-in device (e.g., PMIC 150) may determine the status of the ADC conversion by determining whether the bit (e.g., a “ADC done” bit) of a register in the built-in device (e.g., PMIC 150) indicating a ADC conversion is completed, and send the status of the ADC conversion to the processing device. At operation 360, responsive to receiving the status of the ADC conversion that the ADC conversion is completed, the processing device may retrieve the result of the ADC conversion.

In some implementations, at operation 355, the processing device may determine that the sampling interval is more than a threshold value (e.g., 2 ms), determine that a message (e.g., message 251) has been received, and retrieve the result of the ADC conversion (e.g., the operation shown as 253). The message (e.g., message 251) may be an interrupt, received from the built-in device (e.g., PMIC 150), indicating that the ADC conversion is completed and the result of the ADC conversion is available for retrieving, where the processing device may, responsive to receiving the message, retrieve the result of the ADC conversion that is stored in the data register (e.g., data register 153) of the built-in device (e.g., PMIC 150).

At operation 370, the processing device may exit the power monitoring mode. In some implementations, responsive to retrieving the result of the ADC conversion, the processing device may cause the memory sub-system to exit the power monitoring mode. In some implementations, upon exiting the power monitoring mode, the processing device may store a voltage and a current derived from the ADC conversion. In some implementations, the processing device may store retrieved result in one iteration from the operation 320 to the operation 370, for example, in one entry of a data structure. The retrieved result may include voltage and current. Therefore, for multiple iterations from the operation 320 to the operation 370, the results can be stored in multiple entries of a data structure. FIG. 4 illustrates a data structure 400 that includes multiple entries, where each entry includes a voltage and a current corresponding to a time point. For example, the entry 411 records the time associated with the time point T11, the voltage V11, and the current I11.

At operation 370, the processing device may calculate the power using the retrieved result. In some implementations, the power is calculated by multiplying the voltage with the current. The calculated power may reflect the power consumed by the memory sub-system (e.g., memory sub-system 110) or the memory device (e.g., memory device 130) in the memory sub-system at the specific time point. In some implementations, the processing device may calculate the power in a statistical method. In some implementations, the processing device may store the information (e.g., an indication such as a value) of the calculated power in a log. The log may be a regular or systematic record of the power monitoring performed herein, and may be, for example, in a format of same as or similar to the data structure 400.

In some implementations, the processing device may perform recursively the entering, the exiting, and the calculating until a period of time is reached, wherein a set of powers is obtained during the period of time. In some implementations, the processing device may perform recursively the entering, the exiting, and the calculating until a first period of time is reached, wherein a first set of powers is obtained during the first period of time, and calculate a first statistical value of the first set of powers. In some implementations, the processing device may perform recursively the entering, the exiting, and the calculating until a second period of time is reached, wherein a second set of powers is obtained during the second period of time, and calculate a second statistical value of the second set of powers. In some implementations, the processing device may calculate a third statistical value using the first statistical value and the second statistical value.

As an example, illustrated in FIG. 4, the entry 411 records the time point T11, the voltage V11, the current I11, and the power P11 calculated by voltage V11 and current I11. The processing device may calculate the average power P1 within a first period of time (e.g., T11-T17) of P11, P13, P15, P17, etc. The processing device may calculate the average power P2 within a second period of time (e.g., T21-T27) of P21, P23, P25, P27, etc. The processing device may calculate the average power P3 within a third period of time (e.g., T31-T37) of P31, P33, P35, P37, etc. The processing device may further calculate a maximum power Pmax of the average powers P1, P2, P3, etc. Although the average power and the maximum power are used as examples of the statistical values, other statistical values, such as medium, minimum, etc. are also applicable.

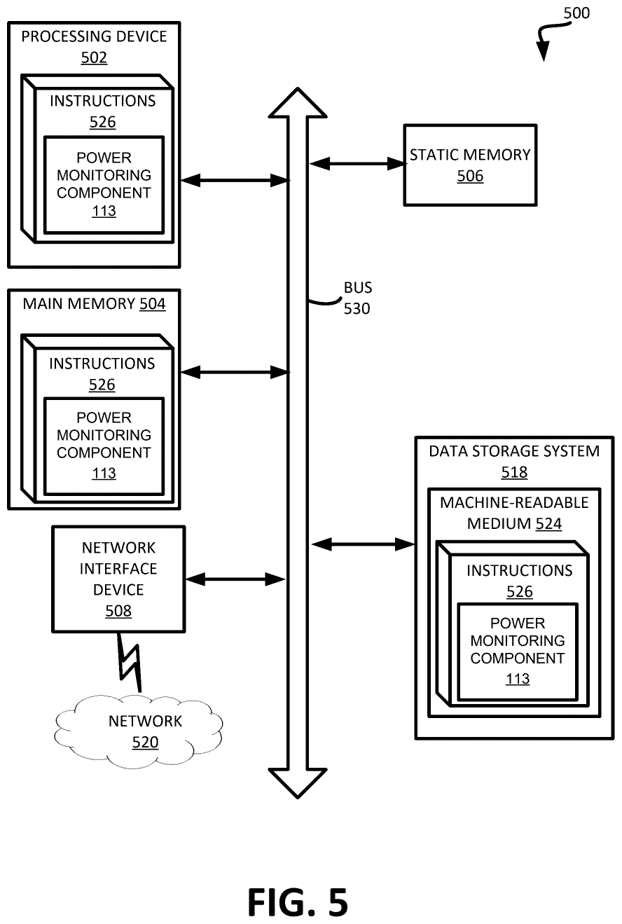

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to power monitoring component 113, memory sub-system controller 115, or local media controller 135 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to power monitoring component 113 of FIG. 1. While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device;
a built-in device that measures a voltage of the memory device; and
a processing device, operatively coupled with the built-in device and the memory device, to perform operations comprising:
detecting a trigger for the system to enter a power monitoring mode;
causing the system to enter the power monitoring mode;
causing the system to exit the power monitoring mode and, upon exiting the power monitoring mode, storing a voltage and a current derived from an analog to digital converter (ADC) conversion;
calculating a power based on the voltage and a current derived from the ADC conversion, wherein the power reflects a power consumption of the system at a specific time point; and
storing an indication of the power in a log.

2. The system of claim 1, wherein the operations further comprise:
determining whether a measurement result is pending to be retrieved from the built-in device; and
responsive to determining that no measurement result is pending to be retrieved from the built-in device, starting the ADC conversion by setting a bit of a register in the built-in device.

3. The system of claim 2, wherein the operations further comprise:
determining whether a sampling interval of power monitoring is less than or equal to a threshold value; and
responsive to determining that the sampling interval is less than or equal to the threshold value, retrieving the voltage and the current derived from the ADC conversion.

4. The system of claim 2, wherein the operations further comprise:
determining whether a sampling interval of power monitoring is more than a threshold value;
responsive to determining that the sampling interval is more than the threshold value, determining that a message is received from the built-in device; and
retrieving the voltage and the current derived from the ADC conversion.

5. The system of claim 1, wherein the operations further comprise:
determining whether a measurement result is pending to be retrieved from the built-in device; and
responsive to determining that the measurement result is pending to be retrieved from the built-in device, retrieving the voltage and the current derived from the ADC conversion.

6. The system of claim 1, wherein the operations further comprise:
performing recursively the entering, the exiting, and the calculating until a first period of time is reached, wherein a first plurality of powers is obtained during the first period of time; and
calculating a first statistical value of the first plurality of powers.

7. The system of claim 6, wherein the operations further comprise:
performing recursively the entering, the exiting, and the calculating until a second period of time is reached, wherein a second plurality of powers is obtained during the second period of time;
calculating a second statistical value of the second plurality of powers; and
calculating a third statistical value using the first statistical value and the second statistical value.

8. The system of claim 1, wherein detecting the trigger further comprises:
setting a timer in a configuration file of the memory device, wherein the timer is activated periodically in a predetermined time interval, and wherein the trigger is detected upon the timer being activated.

9. The system of claim 1, wherein detecting the trigger further comprises:
receiving a message from the built-in device, wherein the trigger is detected upon the message being received.

10. A method, comprising:
detecting, by a processing device, a trigger to enter a power monitoring mode in a memory sub-system, wherein the memory sub-system comprises a memory device and a built-in device that measures a voltage of the memory device;
causing the memory sub-system to enter the power monitoring mode;
causing the memory sub-system to exit the power monitoring mode and, upon exiting the power monitoring mode, storing a voltage and a current derived from an analog to digital converter (ADC) conversion;
calculating a power based on the voltage and a current derived from the ADC conversion, wherein the power reflects a power consumption of the system at a specific time point; and
storing an indication of the power in a log.

11. The method of claim 10, further comprising:
determining whether a measurement result is pending to be retrieved from the built-in device; and
responsive to determining that no measurement result is pending to be retrieved from the built-in device, starting the ADC conversion by setting a bit of a register in the built-in device.

12. The method of claim 11, further comprising:
determining whether a sampling interval of power monitoring is less than or equal to a threshold value; and
responsive to determining that the sampling interval is less than or equal to the threshold value, retrieving the voltage and the current derived from the ADC conversion.

13. The method of claim 11, further comprising:
determining whether a sampling interval of power monitoring is more than a threshold value;
responsive to determining that the sampling interval is more than the threshold value, determining that a message is received from the built-in device; and
retrieving the voltage and the current derived from the ADC conversion.

14. The method of claim 10, further comprising:
determining whether a measurement result is pending to be retrieved from the built-in device; and
responsive to determining that the measurement result is pending to be retrieved from the built-in device, retrieving the voltage and the current derived from the ADC conversion.

15. The method of claim 10, further comprising:
performing recursively the entering, the exiting, and the calculating until a first period of time is reached, wherein a first plurality of powers is obtained during the first period of time; and
calculating a first statistical value of the first plurality of powers.

16. The method of claim 15, further comprising:
performing recursively the entering, the exiting, and the calculating until a second period of time is reached, wherein a second plurality of powers is obtained during the second period of time;
calculating a second statistical value of the second plurality of powers; and
calculating a third statistical value using the first statistical value and the second statistical value.

17. A non-transitory computer-readable storage medium comprising instructions that, when executed by a processing device, cause the processing device to perform operations comprising:
detecting a trigger to enter a power monitoring mode in a memory sub-system, wherein the memory sub-system comprises a memory device and a built-in device that measures a voltage of the memory device;
causing the memory sub-system to enter the power monitoring mode;
causing the memory sub-system to exit the power monitoring mode and, upon exiting the power monitoring mode, storing a voltage and a current derived from an analog to digital converter (ADC) conversion;
calculating a power based on the voltage and a current derived from the ADC conversion, wherein the power reflects a power consumption of the system at a specific time point; and
storing an indication of the power in a log.

18. The non-transitory computer-readable storage medium of claim 17, wherein the operations further comprise:
determining whether a measurement result is pending to be retrieved from the built-in device; and
responsive to determining that no measurement result is pending to be retrieved from the built-in device, starting the ADC conversion by setting a bit of a register in the built-in device.

19. The non-transitory computer-readable storage medium of claim 17, wherein the operations further comprise:
determining whether a measurement result is pending to be retrieved from the built-in device; and
responsive to determining that the measurement result is pending to be retrieved from the built-in device, retrieving the voltage and the current derived from the ADC conversion.

20. The non-transitory computer-readable storage medium of claim 17, wherein the operations further comprise:
performing recursively the entering, the exiting, and the calculating until a first period of time is reached, wherein a first plurality of powers is obtained during the first period of time; and
calculating a first statistical value of the first plurality of powers.
